(19) United States
(12) Patent Application Publication
(10) Pub. No.: US 2009/0279241 A1
(43) Pub. Date: Nov. 12, 2009

(54) COVER FOR A PORTABLE ELECTRONIC DEVICE

(75) Inventors: Shawn R. Gettemy, San Jose, CA (US); William Robert Hanson, Mountain View, CA (US); Eiji Nakagawa, Kyoto (JP)

Correspondence Address: PALM C/O MURABITO, HAO & BARNES LLP, TWO NORTH MARKET STREET, THIRD FLOOR, SAN JOSE, CA, 95113, US

(73) Assignee: PALM, INC., Sunnyvale, CA (US)

(21) Appl. No.: 12/466,763

(22) Filed: May 15, 2009

Related U.S. Application Data
(62) Division of application No. 09/942,837, filed on Aug. 29, 2001.

(51) Int. Cl. G06F 1/16

(52) U.S. Cl. 361/679.26

(57) ABSTRACT

A cover for an electronic device for a portable electronic device is disclosed. The cover may comprise a thin, flexible transparent layer coupled with a supporting structure over a display screen and a digitizer mechanism. The digitizer mechanism may include a flexible conductive paste and a digitizing element. Users input data by applying mechanical pressure on the cover which deflects it and causes the conductive paste to contact and activate the digitizing element disposed beneath. A decorative border may be molded into the cover to conceal the electrical elements of the portable electronic device. The decorative border may be disposed directly beneath the flexible cover. The cover may be dust-free, waterproof, and have an outer surface that is free of any steps, openings, or indentations. Indentations may be molded into the cover to indicate button functions.

### RELATED APPLICATIONS

The present application is a divisional of and claims the benefit of U.S. patent application Ser. No. 09/942,837, filed Aug. 29, 2001, naming Shawn R. Gettemy, William Robert Hanson and Eiji Nakagawa as inventors, assigned to the assignee of the present invention, and having attorney docket number PALM-3651.5G. This application is incorporated herein by reference in its entirety and for all purposes.

### BACKGROUND OF THE INVENTION

Advances in computer technology have enabled the further miniaturization of the components required to build computer systems. As such, new categories of computer systems have been created. One of the newer categories of computer systems is the portable, hand held, or “palmtop” computer system, also referred to as a personal digital assistant or PDA. Other examples of a portable computer system include electronic address books, electronic day planners, electronic schedulers and the like.

A palmtop computer system is a computer that is small enough to be held in the user's hand and as such is “palm-sized.” As a result, palmtops are readily carried about in the user's briefcase, purse, and in some instances, in the user's pocket. By virtue of its size, the palmtop computer, being inherently lightweight, is therefore exceptionally portable and convenient.

Flat panel resistive touch screen displays are used in numerous electronic products such as wrist watches, hand calculators, cell phones, and PDA's both to present information to the user as well as to facilitate input of data such as user touch screen commands. Such displays include a resistive digitizer mechanism and a display mechanism. The resistive digitizer is rigid and only allows minor bending as it is brittle. A typical resistive digitizer mechanism consists of a digitizing element having a flexible thin film supported slightly above the surface of another thin layer digitizing element. A pressure applied to the outer surface of the flexible film causes the film to deflect and contact the bottom digitizing element at a point which can be measured and thereby used as an input signal to activate the digitizer mechanism.

The flexible film and the digitizing element is mounted in a support housing to provide and maintain the proper spacing between the two. At the same time, additional protection against moisture, dust, and mechanical damage must be provided for the flexible film used in the digitizer mechanism. Thus, an additional outer protective film mounted above the digitizer flexible film is generally included in the touch screen display assembly. One problem associated with prior art display interfaces is that the digitizer mechanism is mounted within an enclosure in a recessed fashion. That is, the surface of the additional protective film which actually forms the outer surface of the digitizer mechanism is on a level below the outer edges of the supporting enclosure. This creates a rim or step-down edge surrounding the touch screen which presents the typical bezel-like appearance. These step-down corners add thickness to the assembly, are dust and moisture collectors, are difficult to clean, and frequently do not seal properly. The bezel design adds unwanted thickness to the display components as well as additional complexity and cost of assembly. Additionally, some designers would like to eliminate the bezel to update the appearance of the device.

FIG. 1 is a cross-section view of an enclosure/touch screen assembly 100 utilized in prior art. The entire assembly is held in place by the supporting structure 105. The outer protective film 110 provides mechanical protection for the resistive digitizer film 120. In addition, the outer protective film is coupled to the support mechanism in order to provide a moisture and dust seal. The digitizing element 130 is located below and close to the digitizer film 120. An externally applied pressure that deflects the protective film will also deflect the digitizer film.

Any applied pressure great enough to cause the digitizer film to contact the digitizing element will then activate the resistive digitizer mechanism. The display element 140 is located below the digitizer mechanism. User information is displayed on the upper surface of the display element. An icon sheet (not shown) is frequently disposed above display element 140 which delineates areas on the display screen for specific functions (e.g., button functions or a handwriting recognition area). Together, the protective film, the digitizer film and the digitizing element must have an opacity small enough to allow viewing of the information displayed on the display element.

The entire touch screen assembly is located within the support structure such that the surface of the outer protective film is below the upper edge of the support structure. There is therefore a step-down corner 150 from the upper edge of the support structure to the surface of the outer protective film and the resulting assembly exhibits a bezel like appearance. The support structure is also used to conceal the electrodes 160, insulators 170, and traces 180 which locate where the digitizer film and the digitizing element come into contact with each other.

Another disadvantage with prior art display interfaces is the requirement that the digitizer assembly be a flat, two-dimensional surface. Currently, Indium Tin Oxide (ITO) is used as the conductive material (e.g., digitizer film 120 and digitizing element 130 of FIG. 1) in digitizer mechanisms. The digitizer mechanisms are formed by sputtering ITO onto a flat surface. The flat surface is required because while ITO has some flexibility, it is very brittle and will break down over time. Because of this ITO degradation, the interface of hand held computers needs to be re-calibrated occasionally. The brittleness factor necessitates an ITO layer that is flat and of uniform thickness. Additionally, the junction where the flexible digitizer film joins the electrodes and traces is frequently prone to failure.

The brittleness of the ITO limits the design of prior art devices to a flat interface which may not be suitable for some designs and makes a three-dimensional display surface impractical. A three-dimensional display would allow designers to contour the top surface such that it is not flat giving the device, for example, a curved top profile. The brittleness of the ITO also prevents using a printed decorative border sheet to conceal the electrodes and traces of the digitizer mechanism and eliminate the need for a bezel design.

FIG. 2 is a cross section view which illustrates in greater detail the difficulty in using a decorative border on top of a resistive digitizer mechanism. In FIG. 2, a decorative border 210 has been placed on top of electrode 160 in order to conceal the electrode from a user. A layer of digitizer film 120 comprised of ITO has been deposited in contact with electrode 160 and around decorative border 210 in order to contact outer film 110. In so doing, a corner 220 has been formed which creates a weak area 220 in digitizer film 120. Due to the brittleness of ITO, digitizer film 120 is prone to breakage at this point under normal usage conditions.

### SUMMARY OF THE INVENTION

Accordingly, embodiments of the present invention provide a single-piece three-dimensional display interface. The single piece design in embodiments of the present invention reduces the possibility of damage to electronic components from dust or water. The present invention further provides a display interface which can have a three-dimensional display surface and facilitates better integration of the border, display and icon areas.

Embodiments of the present invention describe a single-piece three-dimensional display cover for an electronic device. In one embodiment, the cover comprises a thin, flexible transparent layer coupled with a supporting structure over a display screen and a digitizer mechanism. The flexible layer has a three-dimensional top surface and a flexible conductive paste disposed beneath it. Users input data by applying mechanical pressure on the cover which deflects the cover and causes the conductive paste to contact and activate a digitizer element disposed beneath. In one embodiment, a decorative border may be in mold decorated into the cover to conceal the electrical elements of the device. For instance the decorative border can be used to conceal the electrodes and other circuits and traces of the touch panel. The conductive paste can then be applied to the underside of the top three-dimensional structure. In another embodiment, the decorative border is disposed directly beneath the flexible cover. The cover is dust-free, waterproof, and has an outer surface that is free of any steps, openings, or indentations. In one embodiment indentations, are molded into the cover to indicate button functions.

More specifically, embodiments of the present invention comprise a digitizer element disposed above a display mechanism. A single-piece top cover encloses the display and digitizer. The single-piece top cover has a layer of flexible conductive paste disposed on the underside facing the digitizer element. When external pressure is applied to the single-piece top cover, it deflects to cause the conductive paste to contact and activate the digitizer element. The point where contact is made between the conductive paste and the digitizer element can be registered as a user input. The single-piece design of the present invention greatly reduces the likelihood of damage by dust or water. Embodiments of the present invention allow designers greater flexibility in that the interface may have a bezel-free three-dimensional top surface which was not practical using a digitizer film made of ITO.

These and other advantages of the present invention will become obvious to those of ordinary skill in the art after having read the following detailed description of the preferred embodiments which are illustrated in the various drawing figures.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a cross section of an enclosure/touch screen assembly utilized in prior art.

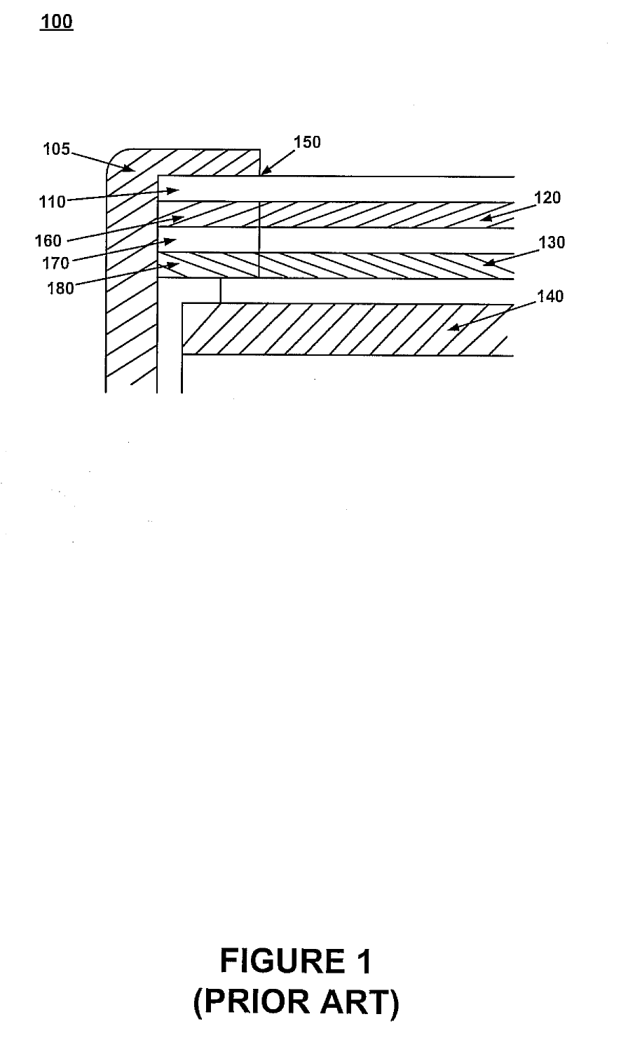

FIG. 2 is a cross section view which illustrates in greater detail the difficulty in using a decorative border on top of a resistive digitizer mechanism.

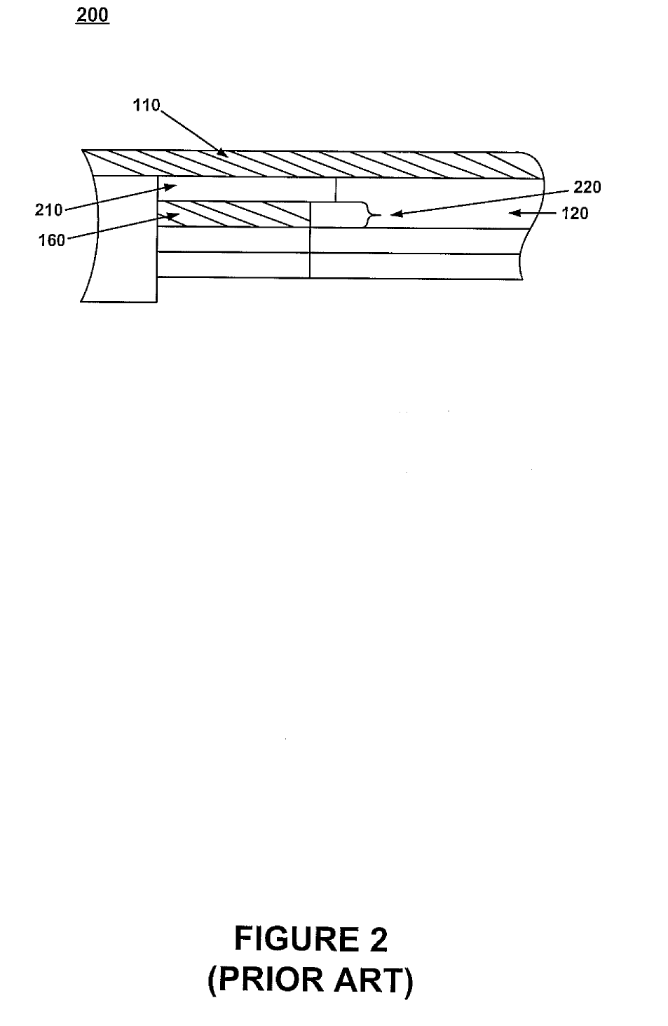

FIG. 3 is a cross section showing an enclosure/touch screen assembly utilized in embodiments of the present invention.

FIG. 4 is a cross section view showing an enclosure/touch screen assembly utilized in embodiments of the present invention.

FIG. 5 illustrates an exemplary portable computer system upon which embodiments of the present invention may be utilized.

### DETAILED DESCRIPTION OF THE INVENTION

A single-piece three-dimensional display cover with an integrated border and display area is described. While numerous details are set forth in order to provide a thorough understanding of the present invention, it should be understood that it is not intended to limit the invention to this particular embodiment alone. On the contrary, the invention is intended to cover alternatives, modifications and equivalents, which may be included within the spirit and scope of the invention as defined by the appended claims. However, it will be obvious to one of ordinary skill in the art that the present invention may be practiced without these specific details. In other instances, well-known methods, procedures, components, and circuits have not been described in detail so as not to unnecessarily obscure aspects of the present invention.

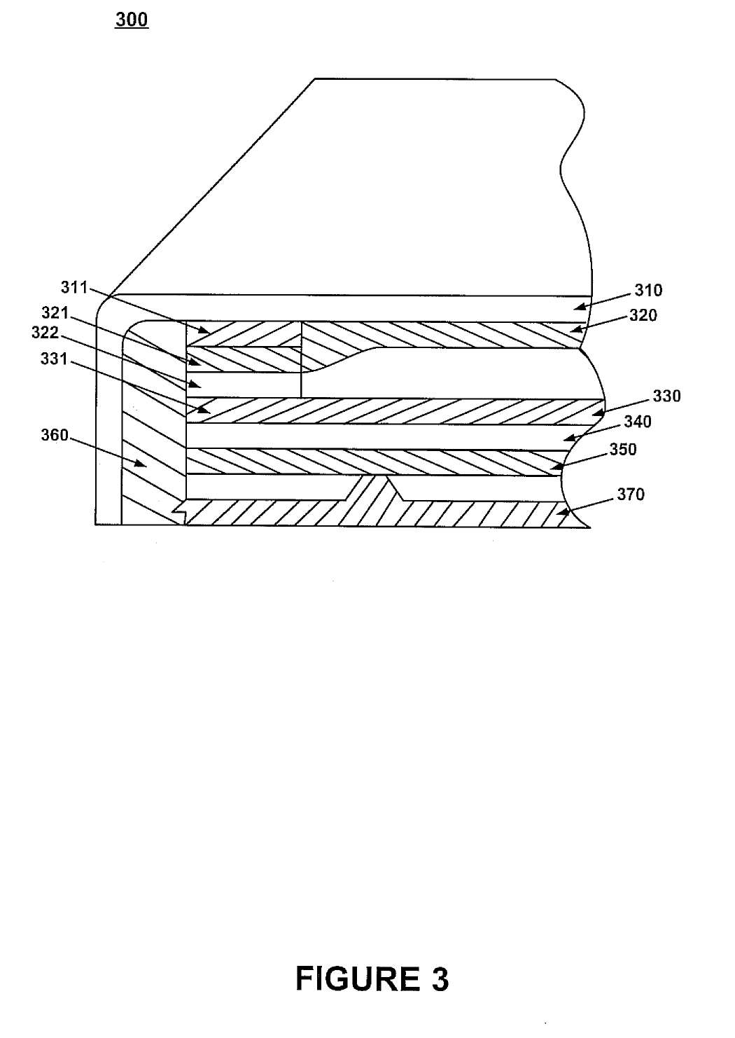

FIG. 3 is a cross section showing an enclosure/touch screen assembly of a device 300 utilized in embodiments of the present invention. Outer film 310 is a single piece of bezel-less transparent flexible thermoplastic that covers the entire top surface of a device such as a Personal Digital Assistant. Numerous types of plastic exist which are suited for this purpose, one of which may be a PET type plastic. In one embodiment, the top surface of outer film 310 has a bezel-free three-dimensional top surface. In the present embodiment of the invention, outer film 310 may be free of any indentations. However, in another embodiment, outer film 310 may have holes or indentations in some portion of the surface for buttons or to indicate button or other like functions.

Outer film 310 is disposed above a digitizer mechanism comprised of conductive layer 320, electrode 321, digitizing element 330, electrical trace 331, and insulator 322. Outer film 310 is flexible in that it has sufficient deflection that a user applying force on the surface of outer film 310 will be able to cause a conductive layer 320 disposed beneath outer film 310 to contact a digitizing element 330 which will input a command to device 300. Outer film 310 is stretched over supporting structure 360.

In one embodiment, conductive layer 320 may be a conductive paste which is commercially available from Acheson Colloids Company of Port Huron, Mich. More specifically, the ELECTRODAG® line of flexible conductive polymers from Acheson Colloids are well suited to be utilized in conductive layer 320. The ELECTRODAG® polymers provide excellent flexibility and adhesion to a wide variety of substrates, as well as a wide range of resistance values. Conductive layer 320 is in contact with and is able to conduct electrical current to electrode 321. Other conductive paste products that are consistent with the discussions herein could also be used.

Above electrode 321 is a decorative border 311 which conceals the electrodes and traces in the touch screen of device 300. In one embodiment, decorative border 311 is a printed or painted film disposed above electrodes 321. In another embodiment, decorative border 311 an in-mold decoration of outer film 310. Decorative border 311 may also delineate areas on the touch screen for specific functions such as buttons or a writing recognition area. By disposing decorative border 311 above the electrodes and traces, the present invention allows more flexibility in designing the appearance of device 300. For example, by using decorative border 311, the step down edge of prior art devices is no longer needed to conceal the electrodes and traces and a bezel-less top surface for device 300 is made possible. Furthermore, colors for decorative border 311 (e.g., colors delineating buttons or specific functional areas) can be more easily matched and coordinated with device 300 if they are deposited as a first step in fabricating the digitizer mechanism.

One benefit of the decorative border is that it can provide the images/decoration of buttons and/or provide a printed graffiti area while also being instrumental in hiding electronic traces, electrodes, and other circuit patterns that are required of the digitizer element. The decorative border may be in mold decorated or printed on the underside of the top flexible surface. Then, the conductive paste can be applied to the underside of the same top flexible surface.

Digitizing element 330 is in contact with and able to conduct electrical current from an electrical trace 331. Whenever conductive layer 320 comes into contact with digitizing element 330, an electrical signal is detected by electrode 312 at a point which can be measured and used as an input signal for device 300. Electrical trace 331 and electrode 321 are separated by an insulator 322.

Supporting structure 360 in the present embodiment of the invention, may be a rigid molded plastic such as PC, PCABS, or ABS and forms a perimeter frame around the top of the electrical device. Supporting structure 360 may be co-molded with outer film 310 to form a single-piece front cover assembly which may form the top surface of device 300. Supporting structure 360 will also provide some method of securely attaching the front cover assembly to a back cover assembly 370, thus forming a dust-proof and waterproof enclosure for the internal components of device 300.

Electronic device 300 further includes a flat display mechanism 350 which is shown as being supported by back cover assembly 370. It is appreciated that back cover assembly may also be supporting a circuit board or boards (not shown) as well. User display information is displayed on the top of display mechanism 350. Display mechanism 350 may be a liquid crystal display, E-INK® imaging film, organic light emitting diode, field emission display, or other suitable technology used to create graphic images and alpha-numeric characters recognizable to a user. A substrate layer 340 is for supporting digitizing element 330.

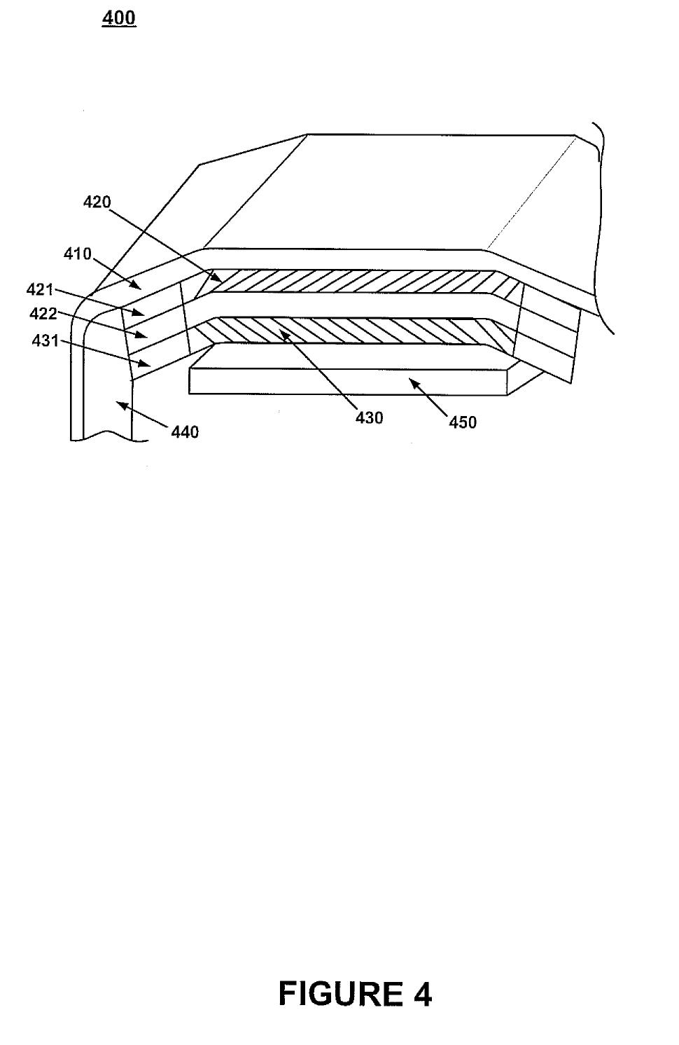

FIG. 4 is a cross section view showing an enclosure/touch screen assembly for a device 400 utilized in embodiments of the present invention. The enclosure/touch screen assembly of FIG. 4 has a curved or three-dimensional top surface which is not found or in not practical in prior art devices due to the brittleness of the ITO commonly used in resistive digitizer mechanisms. The digitizer mechanism of device 400 uses a flexible conductive paste in its digitizer mechanism to overcome this limitation.

Referring now to FIG. 4, outer film 410 is a single piece of bezel-less transparent flexible thermoplastic that covers the entire top surface of a device such as a Personal Digital Assistant and has a curved or 3 dimensional form. Numerous types of plastic exist which are suited for this purpose, one of which may be a PET type plastic. In the present embodiment of the invention, outer film 410 has a three-dimensional top surface free of any indentations. However, in another embodiment, outer film 410 may have holes or indentations in some portion of the surface for buttons or to indicate button or other like functions. Outer film 410 is flexible in that it has sufficient deflection that a user applying force on the surface of outer film 410 will be able to cause conductive layer 420 to contact digitizing element 430 which will input a command to device 400. Outer film 410 is stretched over supporting structure 440.

In one embodiment, conductive layer 420 and digitizing element 430 are a conductive paste which is commercially available from Acheson Colloids Company of Port Huron, Mich. More specifically, the ELECTRODAG® line of flexible conductive polymers from Acheson Colloids are well suited to be utilized in conductive layer 420 and digitizing element 430. The ELECTRODAG® polymers provide excellent flexibility and adhesion to a wide variety of substrates, as well as a wide range of resistance values. Other conductive paste products that are consistent with the discussions herein could also be used. Conductive layer 420 is in contact with and is able to conduct electrical current to electrode 421 and digitizing element 430 is likewise in contact with trace 431. Electrical trace 431 and electrode 421 are separated by layer 422.

Electronic device 400 further includes a flat display mechanism 450 which is supported by a back cover assembly (not shown). User display information is displayed on the top of display mechanism 450. Display mechanism 450 may be a liquid crystal display, E-INK® imaging film, organic light emitting diode, field emission display, or other suitable technology used to create graphic images and alpha-numeric characters recognizable to a user.

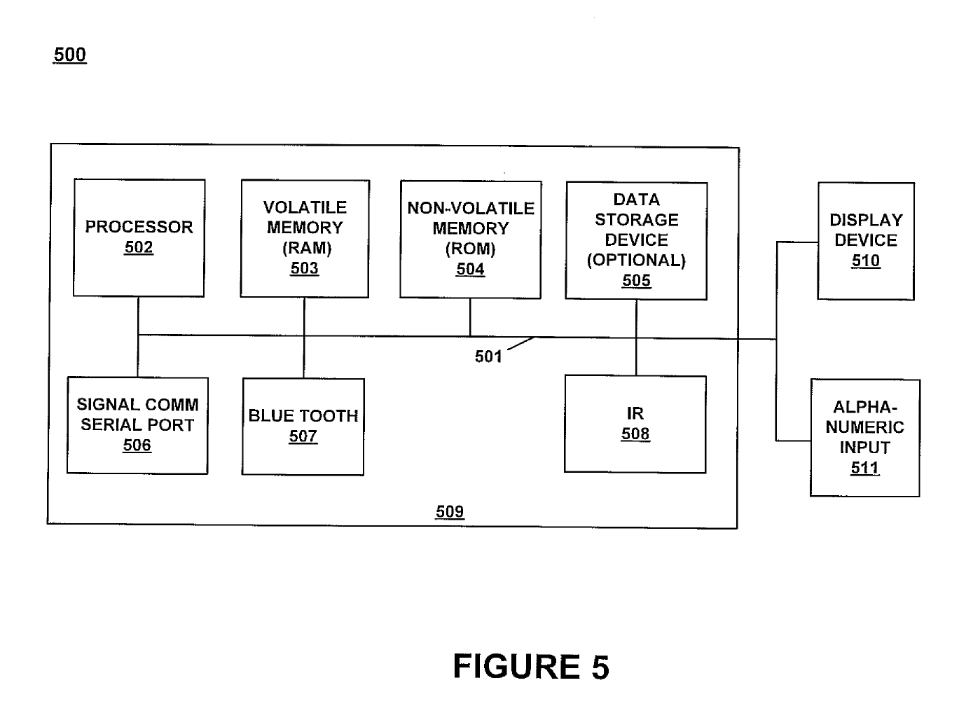

FIG. 5 illustrates exemplary circuitry of portable computer system 500. Computer system 500 includes an address/data bus 501 for communicating information, a central processor 502 coupled with the bus 501 for processing information and instructions, a volatile memory 503 (e.g., random access memory RAM) coupled with the bus 501 for storing information and instructions for the central processor 502 and a non-volatile memory 504 (e.g., read only memory ROM) coupled with the bus 501 for storing static information and instructions for the processor 502. Computer system 500 also includes an optional data storage device 505 (e.g., thin profile removable memory) coupled with the bus 501 for storing information and instructions. Device 505 can be removable.

As described above, system 500 also contains a signal communication device 506, also coupled to bus 501. Signal communication device 506 can be a serial port (or USB port) for communicating with a cradle (not shown). In addition to device 506, wireless communication links can be established between the device 500 and a host computer system (or another portable computer system) using a BLUETOOTH® wireless device 507 or an infrared device 508. These devices are housed on a circuit board 509 which is contained within a cover assembly.

Also included in computer system 500 of FIG. 5 is a display device 510. Display device 510 may be a liquid crystal display, field emission device (FED, also called flat panel CRT), organic light emitting diode (OLED), E-INK® imaging film, or any other display device suitable for creating graphic images and alphanumeric characters recognizable to the user. In one embodiment, the display 510 is a flat panel multi-mode display capable of both monochrome and color display modes.

Device 500 also includes an alphanumeric input device 511 coupled with bus 501. In the present invention, the input device 511 may include a flat panel resistive touch screen display as described above. Input device 511 can communicate information (spatial data) and command selections to the central processor 502. Input device 511 is capable of registering a position on the screen 510 where contact is made.

The preferred embodiment of the present invention, a single-piece three-dimensional display cover for an electronic device is thus described. While the present invention has been described in particular embodiments, it should be appreciated that the present invention should not be construed as limited by such embodiments, but rather construed according to the following claims.

What is claimed is:

1. A portable electronic device comprising:
a display;
a digitizer overlapping said display; and
a housing enclosing said display and said digitizer, wherein said housing comprises:
a top cover comprising at least one bend, wherein said top cover is flexible and is operable to transfer a deformation thereof to said digitizer; and
a bottom cover configured to interface with said top cover; and
wherein said top cover and said bottom cover form a sealed enclosure for said display and said digitizer.

2. The portable electronic device of claim 1, wherein said display comprises a display surface and a first side, wherein said display surface and said first side are not planar, wherein a first portion of said top cover overlaps said display surface, and wherein a second portion of said top cover overlaps said first side of said display, and wherein further said at least one bend joins said first portion and said second portion.

3. The portable electronic device of claim 1, wherein said top cover comprises a flexible thermoplastic film.

4. The portable electronic device of claim 1, wherein said digitizer comprises a conductive polymer and a digitizing element, wherein said conductive polymer is disposed above said digitizing element, wherein said digitizer further comprises a plurality of electrodes and traces operable to register a point of contact responsive to said conductive polymer contacting said digitizing element.

5. The portable electronic device of claim 1, wherein said top cover further comprises a border, wherein said digitizer comprises electrical traces and circuits along a periphery thereof, and wherein said border overlaps said electrical traces and circuits.

6. The portable electronic device of claim 1 further comprising:
a plurality of buttons; and
wherein said top cover comprises at least one indentation, and wherein each of said at least one indentation corresponds to a respective button of said plurality of buttons.

7. The portable electronic device of claim 1, wherein said top cover comprises at least one transparent portion.

8. A portable electronic device comprising:
a display;
a digitizer overlapping said display; and
a housing enclosing said display and said digitizer, wherein said housing comprises:
a top cover, wherein said top cover is flexible and is operable to transfer a deformation thereof to said digitizer;
a bottom cover configured to couple with said top cover; and
a supporting structure configured to couple to said top cover and said bottom cover, wherein said supporting structure is further configured to join said top cover and said bottom cover to form a sealed enclosure for said display and said digitizer.

9. The portable electronic device of claim 8, wherein said top cover comprises at least one bend, wherein said display comprises a display surface and a first side, wherein said display surface and said first side are not planar, wherein a first portion of said top cover overlaps said display surface, and wherein a second portion of said top cover overlaps said first side of said display, and wherein further said at least one bend joins said first portion and said second portion.

10. The portable electronic device of claim 8, wherein said supporting structure is co-molded with said top cover.

11. The portable electronic device of claim 8, wherein said supporting structure is enclosed within said top cover and said bottom cover.

12. The portable electronic device of claim 8, wherein said digitizer comprises a conductive polymer and a digitizing element, wherein said conductive polymer is disposed above said digitizing element, wherein said digitizer further comprises a plurality of electrodes and traces operable to register a point of contact responsive to said conductive polymer contacting said digitizing element.

13. The portable electronic device of claim 8, wherein said top cover further comprises a border, wherein said digitizer comprises electrical traces and circuits along a periphery thereof, and wherein said border overlaps said electrical traces and circuits.

14. The portable electronic device of claim 8 further comprising:
a plurality of buttons; and
wherein said top cover comprises at least one indentation, and wherein each of said at least one indentation corresponds to a respective button of said plurality of buttons.

15. The portable electronic device of claim 8, wherein said top cover comprises at least one transparent portion.

16. A portable electronic device comprising:
a display;
a digitizer overlapping said display; and
a housing enclosing said display and said digitizer, wherein said housing comprises:
a top cover, wherein said top cover is curved, and wherein said top cover is flexible and is operable to transfer a deformation thereof to said digitizer; and
a bottom cover configured to interface with said top cover; and
wherein said top cover and said bottom cover form a sealed enclosure for said display and said digitizer.

17. The portable electronic device of claim 16, wherein said top cover comprises at least one bend, wherein said display comprises a display surface and a first side, wherein said display surface and said first side are not planar, wherein a first portion of said top cover overlaps said display surface, and wherein a second portion of said top cover overlaps said first side of said display, and wherein further said at least one bend joins said first portion and said second portion.

18. The portable electronic device of claim 16, wherein said top cover comprises a flexible thermoplastic film.

19. The portable electronic device of claim 16, wherein said digitizer comprises a conductive polymer and a digitizing element, wherein said conductive polymer is disposed above said digitizing element, wherein said digitizer further comprises a plurality of electrodes and traces operable to register a point of contact responsive to said conductive polymer contacting said digitizing element.

20. The portable electronic device of claim 16, wherein said top cover further comprises a border, wherein said digitizer comprises electrical traces and circuits along a periphery, and wherein said border overlaps said electrical traces and circuits.

21. The portable electronic device of claim 16 further comprising:
a plurality of buttons; and
wherein said top cover comprises at least one indentation, and wherein each of said at least one indentation corresponds to a respective button of said plurality of buttons.

22. The portable electronic device of claim 16, wherein said top cover comprises at least one transparent portion.
